(19) United States
(12) Patent Application Publication
(10) Pub. No.: US 2012/0189895 A1
(43) Pub. Date: Jul. 26, 2012

(54) ELECTRODE STACK FOR A GALVANIC CELL

(75) Inventors: Andreas Gutsch, Luedinghausen (DE); Tim Schaefer, Niedersachswerfen (DE); Guenter Eichinger, Altenstadt (DE)

(73) Assignee: LI-TEC BATTERY GMBH, Kamenz (DE)

(21) Appl. No.: 13/256,730

(22) PCT Filed: Mar. 15, 2010
(86) PCT No.: PCT/EP10/01621

§ 371 Date: Mar. 27, 2012

(30) Foreign Application Priority Data
Mar. 16, 2009 (DE) 10 2009 013 345.3

(51) Int. Cl. H01M 10/04; H01M 2/20; H01M 2/18

(52) U.S. Cl. 429/144; 429/162; 29/623.3

(57) ABSTRACT

An electrode stack according to the invention comprises at least a cathode, an anode, and a separator with electrolyte. The cathode, the anode, and the separator are each plate-shaped, respectively. The surface area of the separator is at least as large, as the surface area of the cathode and/or of the anode. The plate-shaped elements of the electrode stack are at least partially connected with each other, by fixation means.

Priority application DE 10 2009 013 345 as filed on Mar. 16, 2009 is fully incorporated by reference herein.

The invention relates to an electrode stack for a galvanic cell, characterized in that the layers of the electrode stack are each formed as a plate-shaped element.

Galvanic cells are known from the prior art, whose actual charging capacity already drops below the calculated charging capacity after manufacture. In addition, galvanic cells are known, whose charging capacity decreases during operation.

From DE 199 43 961 A1, a flat cell of the above mentioned type is known, in which the separator has a larger surface area than the cathode and the anode. Said known flat cell comprises housing parts, in which the cathode or the anode are inserted. To finalize the manufacture of the cell, the housing parts are connected with each other by means of a sealing material.

CH 69 47 15 A5 relates to a lithium-flat cell, for which the cathode, the anode, and the separator have different lengths, wherein the separator is designed to be the longest part. The housing parts, which take up the cathode and the anode, are connected with each other via an extension of the separator and a corresponding insulating material, wherein a closed housing is formed.

It is the objective of the present invention, to provide an electrode stack for a galvanic cell, whose calculated charging capacity also largely remains stable during the operation of the electrode stack, or, respectively, of an associated galvanic cell.

According to the invention, the objective is achieved by the teaching of the independent claims. Claim 9 describes a method for the manufacture of an electrode stack to achieve the objective of the invention. Claim 15 describes a method for the manufacture of a galvanic cell with an electrode stack according to the invention.

An electrode stack according to the invention has at least a cathode, an anode, and a separator with an electrolyte. The cathode, the anode, and the separator are each designed plate-shaped, respectively. The surface area of the separator is at least as large as the surface area of the cathode and/or of the anode. The plate-shaped elements of the electrode stack are at least partially linked with each other by fixation means.

According to the present invention, a galvanic cell refers to a device, which is also used for the storage of chemical energy and for the discharge of electrical energy. For this purpose the galvanic cell according to the invention has at least one electrode stack. The galvanic cell can also be configured to take up electrical energy during a charging process. This then refers to a secondary cell or to an accumulator.

According to the present invention, an electrode stack refers to a device, which, as a component of a galvanic cell, is also used for the storage of chemical energy and for the discharge of electrical energy. For this purpose, the electrode stack has several plate-shaped elements, at least two electrodes, an anode and a cathode, and a separator, which at least partially absorbs the electrolyte. Preferably, at least an anode, a separator, and a cathode are placed or stacked above each other, wherein the separator is arranged at least partially between the anode and the cathode. This sequential arrangement of anode, separator, and cathode may be repeated as often as designated within the electrode stack. Preferably, the plate-shaped elements are wound up to an electrode-coil. In the following, the term “electrode stack” is also used for an “electrode-coil” (wound or rolled electrode stack). Prior to the discharge of electrical energy, the chemical energy as stored is converted into electrical energy. During the charging process, the electrical energy, which is supplied to the electrode stack or, respectively, to the galvanic cell, is converted into chemical energy and stored.

Preferably, the electrode stack comprises several pairs of electrodes and several separators. Particularly preferably, some electrodes are connected to each other, in particular, by electrical means.

According to the present invention, an anode refers to a device, which, accommodates positively charged ions on interstitial sites during the charging process. Preferably, the anode is designed to be thin-walled, particularly preferably, as a metal foil. Preferably, the anode is, essentially, rectangularly shaped.

According to the present invention, a cathode refers to a device, which also takes up electrons and positively charged ions during the discharging process or, respectively, during the discharge of electrical energy. Preferably, the cathode is designed to be thin-walled, particularly preferably, as a metal foil. Preferably, the shape of a cathode essentially corresponds to the shape of an anode of the electrode stack. The cathode is also provided for the electrochemical interaction with the anode, or, respectively, with the electrolyte.

According to the present invention, a separator refers to a device, which separates an anode from a cathode to keep them at a distance. The separator also takes up the electrolyte, at least partially. Preferably, a separator is designed to be thin-walled, particularly preferably, as a polymer film. Preferably, the shape of a separator essentially corresponds to the shape of an anode of the electrode stack. Preferably, a separator is provided to have a non-woven web of electrically non-conductive fibers, wherein the non-woven web is coated, on at least one side, with an inorganic material. EP 1 017 476 B1 describes such a separator and a method for the manufacture the same. A separator with the above mentioned features is currently available under the tradename “Separion” from Evonik AG, Germany.

According to the present invention, a fixation means is a device, which joins together at least two plate-shaped elements of an electrode stack, in particular by force-fit and/or by material engagement. A fixation means is also used to prevent relative movements of two plate-shaped elements of the electrode stack, in particular, an undesirable shift of at least one plate-shaped element. Preferably, more than two plate-shaped elements of the electrode stack are joined together, respectively. Particularly preferably, all plate-shaped elements of the electrode are joined together.

Preferably, adhesives, adhesive tapes, a solder, or a weld are also used as fixation means

During operation, an undesirable shift of at least one plate-shaped element of the electrode stack may occur due to vibrations or accelerations. Also, already when inserting the electrode stack into a housing, or, respectively, into a packaging, an undesirable shift of at least one plate-shaped element may occur In case an electrode is not located at its designated place within the electrode stack, the chemical interaction with other plate-shaped elements of the electrode stack is also reduced, in particular, the conversion or, respectively, the storage of energy. Thereby, the actual charging capacity of the electrode stack is reduced.

With the joining or the fixation of plate-shaped elements of the electrode stack an undesirable shift of individual plate-shaped elements is reduced. The chemically active areas of the electrode stack are available for the conversion or, respectively, for the the storage of energy.

The chemically active areas of the plate-shaped element with the smallest surface lie completely within the electrode stack. By this, the underlying objective of the invention is achieved.

In the following, preferred embodiments of the invention are described.

Advantageously, the length and/or the width of the separator is larger than the corresponding lengths and/or widths of the electrodes, i.e. of the anode and/or of the cathode. In case the plate-shaped elements are combined or, respectively, stacked to result in a stack of electrodes, the separator extends, partially and in respect to some areas, beyond the electrodes.

Preferably, the plate-shaped elements are designed and put together such that the separator extends beyond each limiting edge or, respectively, beyond the edges of the electrodes. Advantageously, possible energy losses along the edges of the electrodes can thus be reduced.

Advantageously, the anode and the cathode have surfaces areas of different size. For economic reasons, it would seem to bee desirable that the electrodes are of the same size. However, this requires a precise assembly or, respectively, stacking of the electrode stack. Even small shifts of an electrode or edges of electrodes, which are not aligned in parallel, may result in areas of an electrode, which are not available for the conversion/storage of energy. The actual charging capacity of the electrode stack would be reduced.

In case, an electrode is designed having a larger size, a limited shift of said electrode from its predetermined position does not lead to the situation, that the smaller electrode is no longer opposed by a chemically active area of the larger electrode. Choosing a dimension according to the claims, allows for larger tolerances, preferably, and to a certain extend a less precise assembly of the electrode stack.

Advantageously, the separator extends at least partially beyond an electrode, in particular, beyond the larger electrode. Preferably, the separator extends by 0.01 to 10 mm, more preferably by 1 to 3 mm, beyond an electrode, in particular, beyond the larger electrode. Advantageously, possible energy losses along the edges of the electrodes are also reduced.

Advantageously, the cathode and the anode each have at least one collector tab, which comprises an electrically-conductive material. A collector tab is also used for the contacting of an electrode. Preferably, a collector tab is connected with an electrode in an electrically-conductive manner. Preferably, a collector tab is formed to an electrode in one piece. Preferably, the collector tabs of the anode and the cathode are congruent. (“deckungsgleich”) Preferably, the electrodes of the electrode stack are arranged such that one edge each or, respectively, one boundary edge each of at least two collector tabs die in parallel.

Preferably, at least one collector tab of each of two electrodes is connected in an electrically conductive manner with each other, in particular by means of soldering or welding. Preferably, at least one collector tab of each of two electrodes is connected to a “conductor” in an electrically-conductive manner in particular, by means of a welded connection.

In case the electrode stack comprises a plurality of anodes and of cathodes, an electrical circuit is implemented in series and/or in parallel, preferably, by means of at least one electrically-conductive connection of several collector tabs of different electrodes.

Advantageously, the connection of the plate-shaped elements of the electrode stack is provided as an adhesive bond. In particular, the adhesive is present as at least one adhesive strip. Therein, at least one adhesive strip also fixates the plate-shaped elements, both during the manufacture as well as later, during the subsequent operational use. The adhesive strip comprises an adhesive, which is applied to a carrier material, wherein the carrier material remains, in particular, permanently connected to the plate-shaped elements, and thereby, also transmits forces. The carrier material, preferably, comprises PET or a polyamide and is resistant towards the electrolyte. Acrylate or silicone adhesives are preferably used as adhesives.

Preferably at least one adhesive strip is applied to at least one outer edge of one or several of the plate-shaped elements. Preferably, at least one adhesive strip runs at least partially or completely around the electrode stack. Preferably at least one adhesive strip is applied to at least one corner of the electrode stack.

Preferably, at least one adhesive strip is part of a frame, which surrounds the plate-shaped elements, and which stabilizes the electrode stack. Advantageously, the adhesive strip does not have to be manufactured in addition to the frame and applied to the frame.

Preferably, the adhesive is applied as at least one spot of adhesive between the plate-shaped elements, in particular, to the corners of the plate-shaped elements.

A spot of adhesive is easy to apply to well-defined locations and also provides a proper fixation of the elements of the electrode stack. Preferably plate-shaped elements are connected by means of several spots of adhesive, in particular, at the corners of the electrode stack.

Preferably at least one adhesive bead (“Kleberaupe”) is provided between the plate-shaped elements, or along at least one edge of a plate-shaped element. Particularly preferably, several plate-shaped elements are connected together along their boundary edges by means of multiple adhesive beads. Such adhesive beads not only stabilize the assembly of individual plate-shaped elements of the electrode stack to one another, but also advantageously, act as an additional insulation for the reduction of energy losses at the boundary edges of the electrodes.

Advantageously, a galvanic cell comprises an electrode stack of the type described above, a packaging or, respectively, an envelope of the electrode stack, and electrical connectors or, respectively, conductors to the electrodes. The packaging also separates the electrode stack from the environment, and prevents leakage of the electrolyte. By fixing the plate-shaped elements of the electrode stack to each other, such an electrode stack is particularly suitable for the tailoring of a galvanic cell. Advantageously, the mutually fixed position of the plate-shaped elements of the electrode stack remains fixed during the subsequent operation of the galvanic cell.

According to the invention, the electrode stack is manufactured, as described below. The electrode stack has at least one cathode, one anode, and one separator, which are shaped as plate-shaped elements, respectively. The plate-shaped elements are cut such, that after cutting, the separator comprises a larger surface area than the cathode and/or the anode. The plate-shaped elements as cut are superimposed or, respectively, stacked. After stacking, the plate-shaped elements of the electrode stack are connected in relation to each other or, respectively, with each other.

By means of cutting the plate-shaped elements of the electrode stack in this manner, by the subsequent stacking of these plate-shaped elements, and by fixation after stacking, a simple and reliable method is provided, which ensures, in an advantageous manner, both optimal utilization of the calculated charging capacity, as well as stability of the electrode stack during operation.

Advantageously, the electrode stack is manufactured such, that its plate-shaped elements are positioned during stacking with at least one positioning means, in particular, with at least a positioning device (“Schablone”) or a frame. A positioning means is also used to arrange a separator between an anode and a cathode such that the separator extends circumferentially and beyond the edges of the contacting electrodes. In case the anode and the cathode have different surface areas, a positioning means is also used to arrange the smaller electrode within the edges of the larger electrode.

Preferably, a positioning means has at least one stop for each of at least one boundary edge of a plate-shaped element.

Preferably, a positioning means is configured such that it provides, as part of a manufacturing device, an automated positioning of plate-shaped elements.

Advantageously, the electrode stack, whose electrodes each comprise at least one collector tab, is manufactured such that at least one collector tab of each of a cathode and/or of an anode is used for positioning. This way, in particular, the boundary edges of the collector tabs are aligned in parallel. Preferably, when manufacturing the electrode stack, in particular, during stacking of the plate-shaped elements, a positioning means engages with the collector tabs. In particular, a positioning means has at least one stop for each of at least one boundary edge of a collector tab.

Advantageously, the electrode stack, whose electrodes each comprise at least one collector tab, is manufactured such that, after positioning, at least two collector tabs are connected to each other. This connection preferably is performed by means of soldering or welding. Depending on the assembly of the electrodes or, respectively, of their collector tabs, the electrodes, can be connected in parallel and/or in series. Preferably, a so-called “conductor” is connected together with at least two collector tabs. This conductor is also used for the power supply to or from the consumer.

Advantageously, the electrode stack is manufactured such, that at least two plate-shaped elements are connected with at least one adhesive strip. Preferably, several plate-shaped elements are connected by at least one adhesive strip. Preferably, at least one adhesive strip is applied, at least partially, along at least one of each boundary edge of at least two plate-shaped elements. Preferably, at least one adhesive strip is applied to each of at least one corner of at least two plate-shaped elements. Preferably, at least one adhesive strip is applied around the electrode stack.

Advantageously, the electrode stack is manufactured such, that at least one spot of adhesive is applied to connect at least two plate-shaped elements. The at least one spot of adhesive is preferably applied between two plate-shaped elements. Preferably, at least one spot of adhesive is applied to one of each boundary edge of at least two plate-shaped elements. Preferably, at least one adhesive bead is applied between two plate-shaped elements. Preferably, at least one adhesive bead is applied partially along one of each boundary edge of at least two plate-shaped elements.

Advantageously, before stacking, fixation means are applied to the plate-shaped elements of the electrode stack. This way, the stack is already fixed before the completion so that an alignment of the the plate-shaped elements of the electrode stack that would otherwise eventually be necessary may be avoided.

In this case, the fixation means can be adhesive strips or spots of adhesive, wherein the material of the adhesive does however, not necessarily have to be stable towards the electrolyte, since these fixation means only have to persist during the manufacturing steps. Afterwards, i.e. after stacking and the configuring, they are replaced by these fixation means. Preferably, a liquid adhesive or a heat adhesive, which cure instantly, is chosen as fixation means, which is applied before stacking the plate-shaped elements of the electrode stack. Preferably, said adhesive is an acrylate adhesive or an EVA -modified PE-hot-melt adhesive.

Advantageously, a galvanic cell is manufactured such, that an electrode stack, which has been manufactured in the manner described above, is transferred into a packaging. This way, the prefixing of the stack during the manufacture is beneficial both for the insertion of the electrode stack into the packaging, as well as later during the operation of the electrode stack within the packaging. In particular, the packing can be of a composite film or of a rigid (in respect to bending) housing. The packaging also separates the electrode stack from the environment and prevents the leakage of the electrolyte.

Below, embodiments of the invention are described by reference to the figures:

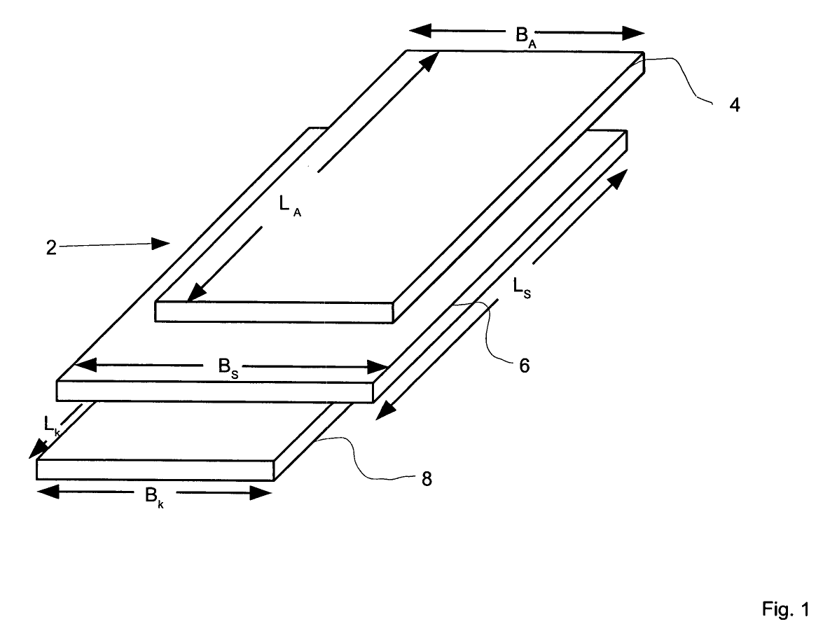

FIG. 1 shows a schematic view of the relative sizes of the plate-shaped elements of the electrode stack;

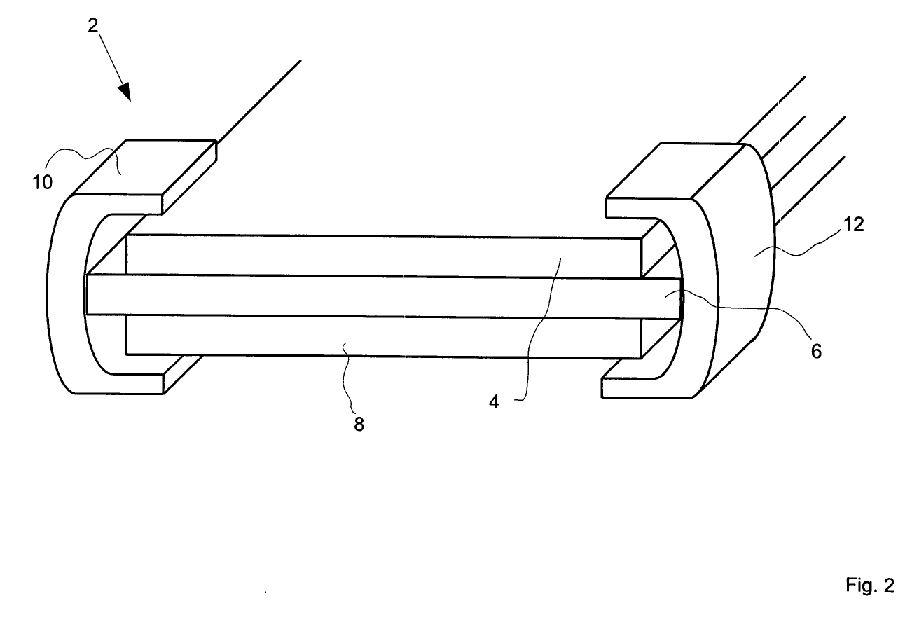

FIG. 2 shows an embodiment of the invention, in which adhesive strips are applied to edges of the electrode stack;

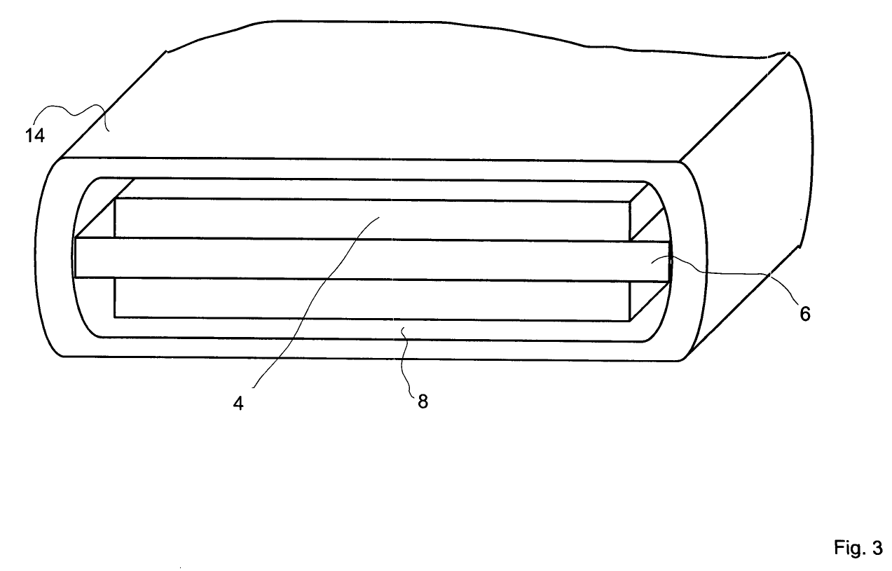

FIG. 3 shows an embodiment of the invention in which an adhesive strip is applied completely around one end of the electrode stack;

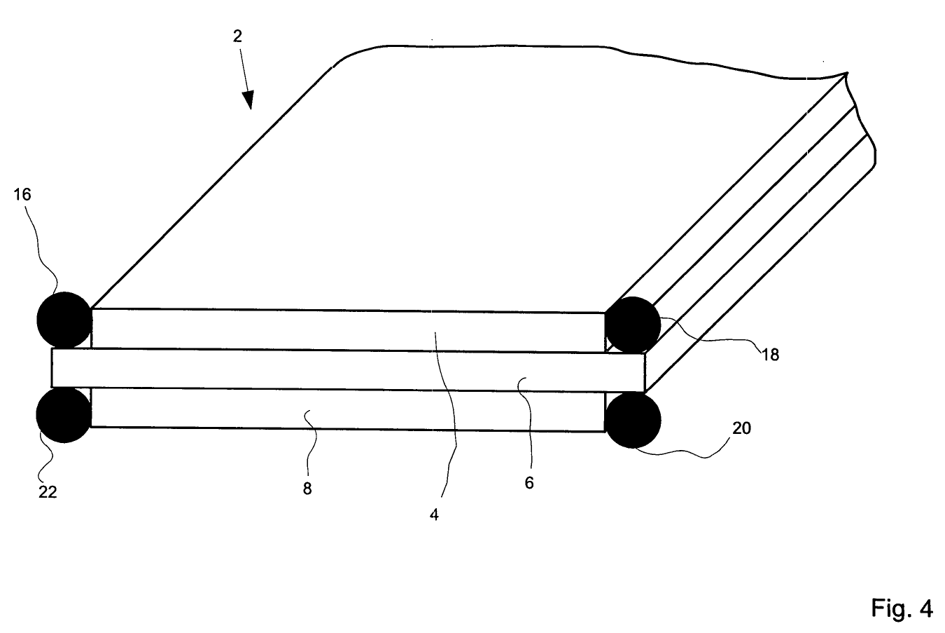

FIG. 4 shows an embodiment of the invention, in which spots of adhesive are provided to the corners of the plate-shaped elements of the electrode stack for fixing the same;

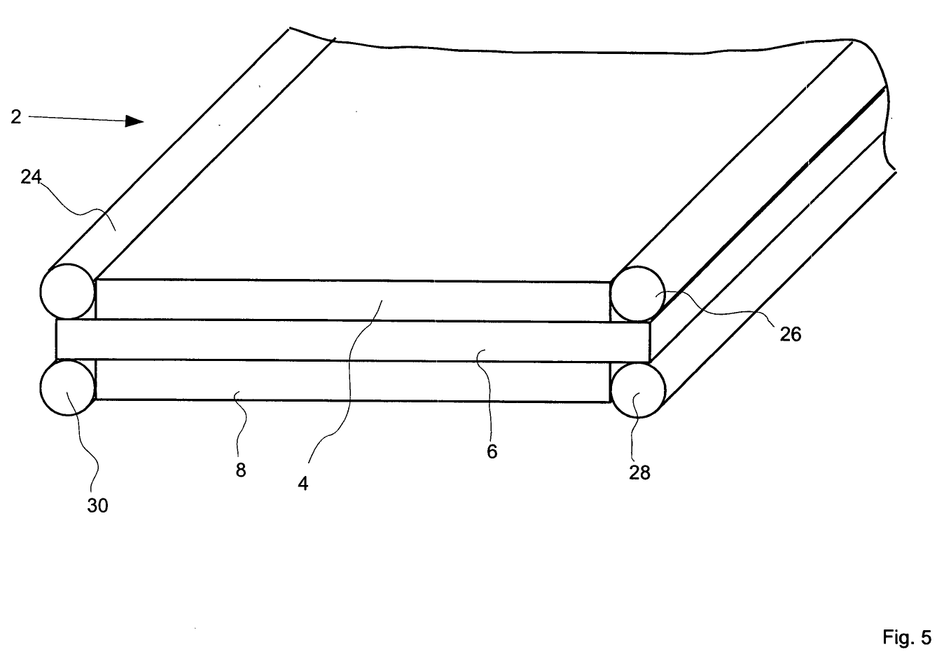

FIG. 5 shows an embodiment of the invention, in which adhesive beads are applied to the two longitudinal edges of the electrode stack,

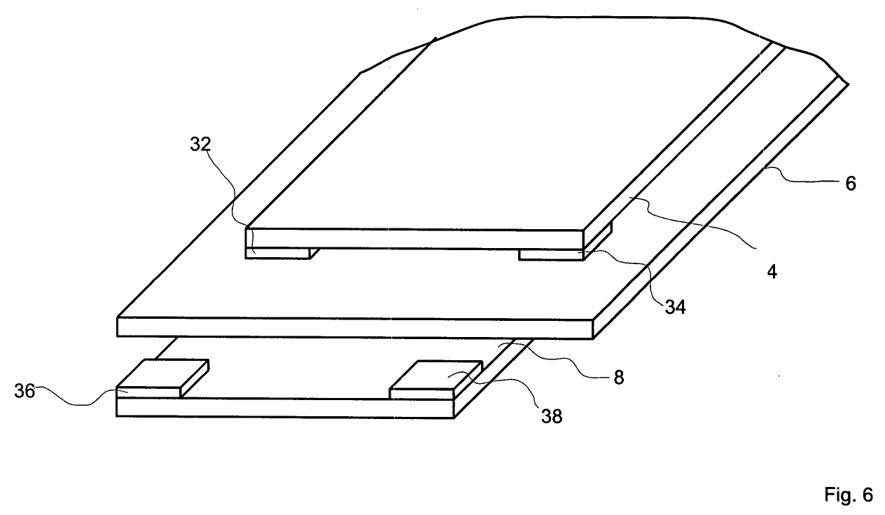

FIG. 6 shows an embodiment of the invention, in which adhesive areas are applied to plate-shaped elements for fixing the elements during stacking.

According to FIG. 1, an electrode stack 2 has an anode 4, a separator 6 and a cathode 8. The length L_{A} of the anode is greater than its width B_{A}. The separator 6 has a length L_{S} and a width B_{S}, wherein in this embodiment, the length L_{S} of the separator is greater than the length L_{A} of the anode 4. The width B_{S} of the separator 6 is also greater than the width B_{A} of the anode 4. Furthermore, the length L_{K} of the cathode 8 is greater than the width B_{K} of the cathode. The width and length of the cathode 8 are each smaller than the width and the length of the separator 6.

Anode 4 may also be as large as cathode 8, or one of the two electrodes can be greater than the other electrode. In case the lengths of the plate-shaped elements are equal to each other, the width dimensions have to be at least such, that the separator 6, in particular its surface area, is greater than the anode 4 and/or the cathode 8.

Conversely, when the widths of the elements are equal to each other, the length L_{S} of the separator 6 will be greater than the length L_{A} or, respectively, L_{K} of the anode 4 or, respectively, of the cathode 8.

FIG. 2 schematically shows an electrode stack of the anode 4, the separator 6, and the cathode 8, which are fixed to each other by means of adhesive strips 10, 12 on the sides. Adhesive strips 10, 12 extend only over a portion of the length of the electrode stack 2 The adhesive strips may, however, also run along the entire length of the electrode stack. Adhesive strips 10, 12 should however, be applied to one or all side(s) of the electrode stack, at the site, where the corresponding dimensions of the plate-like elements are different from each other, as described above.

FIG. 3 shows an embodiment of the invention in which an adhesive strip 14 is placed on one end of the electrode stack 2, around its anode 4, the separator 6, and the cathode 8.

FIG. 4 shows an embodiment of the invention, in which spots of adhesive 16, 18, 20, 22 are each provided, respectively, to the corners of the electrode stack 2, in order to fix the plate-shaped elements of the electrode stack 2 against each other.

FIG. 5 shows an embodiment of the invention, in which adhesive beads 24, 26, 28, 30 are each applied, respectively, on the longitudinal sides of the anode 4, the separator 6, and the cathode 8, to connect and to stabilize the plate-shaped elements with each other.

FIG. 6 shows an exploded view of an anode 4, a separator 6, and a cathode 8 prior to assembly. On each of the the corners of the anode 4, an adhesive layer 32, 34, and on the corners of the cathode, adhesive layers 36, 38 are, respectively, provided, which, when stacking the plate-shaped elements, each establish a connection with the surface area of the separator 6, and which are then, pressed, to be essentially, flat. Adhesive layers 32, 34 or, respectively, 36, 38 may extent as dots or cover larger areas, on few sites of the electrode stack 2, for example, on the corners or on the side edges.

Adhesive layers 32, 34 or, respectively, 36, 38 are used for the at least temporary fixation of the plate-shaped elements of the stack during stacking. When these adhesive layers 32, 34, or, respectively, 36, 38 are made of a material, which is not resistant towards the electrolyte, they may also dissolve again after stacking, since in this case, the fixation is replaced by means of the adhesive strips, the spots of adhesive, or, respectively, by adhesive beads, so that the fixation of the plate-shaped elements of the electrode stack, will remain.

1.-15. (canceled)

16. Electrode stack having at least
a cathode (8),
an anode (4),
and a separator (6) with an electrolyte,
wherein the cathode (8), the anode (4), and the separator (6) are plate-shaped, respectively;
wherein the separator (6) has a larger surface area than the cathode (8) and/or the anode (4), and
wherein the plate-shaped elements of the electrode stack (2) are at least partially connected with each other by fixation means,
wherein,
at least one fixation means is an adhesive strip.

17. The electrode stack according to claim 16, wherein the at least one adhesive strip comprises a carrier material, which remains permanently connected to the plate-shaped elements and which is resistant towards the electrolyte, wherein said carrier material comprises PET or polyamide and on which an adhesive is applied.

18. The electrode stack according to claim 17, wherein the at least one adhesive strip is applied to at least one outer edge of a plate-shaped element (4, 6, 8), to at least one corner of a plate-shaped element (4, 6, 8), or around the electrode stack (2).

19. The electrode stack according to claim 18, which has essentially rectangular, plate-shaped elements, wherein at least one dimension of the separator (6) is larger than a corresponding dimension of the cathode (8) or of the anode (4).

20. The electrode stack according to claim 19, wherein at least one dimension of the anode (4) is different from a corresponding dimension of the cathode (8).

21. The electrode stack according to claim 20, wherein at least one dimension of the separator (6) is larger by 0.01 to 10 mm than a corresponding dimension of the cathode (8) or the anode (4).

22. The electrode stack according to claim 21, wherein at least one collector tab is assigned to a cathode (8) and to an anode (4), respectively, wherein the collector tabs are provided such that they may be connected.

23. The electrode stack according claim 22, wherein the contact of the plate-shaped elements of the electrode stack is realized as an adhesive bond.

24. A galvanic cell comprising at least one electrode stack (2) according to claim 16, and a casing, which surrounds the electrode stack (2) at least partially, and having two electrical conductors, which are assigned to the electrodes (4, 8), and which at least partially, protrude through the casing.

25. The electrode stack according to claim 23, wherein the separator comprises a non-woven web of electrically non-conductive fibers, and wherein the non-woven web is coated on at least one side with an inorganic material.

26. A process for the manufacture of an electrode stack (2) according to claim 16 comprising at least a cathode (8), an anode (4), and a separator (6), comprising the steps of:
cutting and stacking plate-shaped elements (4, 6, 8),
in which the separator (6) is cut with a larger surface area, than the cathode (8) or the anode (4),
and connecting the plate-shaped elements (4, 6, 8) of the electrode stack (2) to each other after stacking.

27. The process according to claim 26, wherein the plate-shaped elements (4, 6, 8) of the electrode stack (2) are positioned during the stacking, wherein at least one means for positioning is used.

28. The process according to claim 27, wherein at least one cathode (8) and at least one anode (4), are each connected electrically-conductive to at least one collector tab, wherein the plate-shaped elements (4, 6, 8) of the electrode stack (2) are positioned during the stacking by means of the collector tabs of the cathode (8) or the anode (4).

29. The process according to claim 27, wherein at least a cathode (8) and at least an anode (4), are each connected in an electrically-conductive manner to at least one collector tab, wherein at least two collector tabs are connected in an electrically-conductive manner to each other by means of welding.

30. The process according to claim 29, wherein at least one adhesive strip is attached to at least one outer edge of a plate-shaped element (4, 6, 8), to at least one corner of a plate-shaped element (4, 6, 8) or around the electrode stack (2), wherein as an adhesive an acrylate adhesive or silicone adhesive is used.

31. The process according to claim 30, wherein at least one spot of adhesive is applied between the plate-shaped elements (4, 6, 8) or to at least one edge of each of two adjacent, plate-shaped elements (4, 6, 8) before stacking, wherein as an adhesive an acrylate adhesive or an EVA-modified PE-hot-melt adhesive is used.

32. The process for the manufacture of a galvanic cell, characterized in that an electrode stack (2), manufactured according to claim 26 is transferred into a packaging.
